(19) United States
(12) Patent Application Publication
(10) Pub. No.: US 2014/0293421 A1
(43) Pub. Date: Oct. 2, 2014

(54) THREE-SIDED REFLECTOR FOR USE ON SIGN POST

(71) Applicant: ZUMAR INDUSTRIES, INC., Tacoma, WA (US)

(72) Inventor: Thomas Brandes, Bellevue, WA (US)

(73) Assignee: Zumar Industries, Inc., Tacoma, WA (US)

(21) Appl. No.: 13/853,804

(22) Filed: Mar. 29, 2013

(51) Int. Cl. G02B 5/12; B21D 5/02

(52) U.S. Cl. CPC G02B 5/12; B21D 5/02
USPC 359/552; 359/515; 156/196; 427/162; 29/592; 72/372

(57) ABSTRACT

A three-sided reflected is formed to include a front and two adjacent sides that are sized to encompass a sign post. This three-sided reflector is then attached to the sign post so that the front faces in the same direction as a front of the sign post. A highly visible material having a bright or fluorescent color and optionally including retro reflectors is disposed on each of the outer surfaces of the front and the two adjacent sides of the reflector so that incident light is reflected back toward a driver of a vehicle that is approaching the front or either side of the sign post. The reflected light greatly increases the visual perception of the sign post by a driver of the vehicle so that it much less likely that the driver will strike the sign post with the vehicle.

### BACKGROUND

Road signs have become ubiquitous along streets and highways throughout the world. These signs are employed for many purposes, including controlling how we drive, indicating maximum/minimum speed limits, identifying potentially dangerous conditions, and providing information, to name just a few. Every road sign must be supported, either on an existing support or on one or more sign posts that are installed specifically for that purpose along the side of the roadway. Although sign posts are generally never installed in the normal traffic lanes, they are often installed along the side of or between roadways and traffic lanes, where an inadvertent motorist may accidentally strike them.

Sign posts are typically relatively small in cross-sectional size, compared to the sign(s) that they support, and, as a result, are not readily visible. Many road signs are provided with very bright or reflective surfaces that are readily visible to oncoming traffic. However, drivers approach a road sign from the side, for example, while in a traffic lane or roadway that intercepts the roadway along which the sign post has been installed, will only be visually exposed to the edge of the road sign and the side of the sign post. In such cases, it is easy to understand why drivers may not visually perceive the presence of the sign post and as a result, may strike the sign post. This problem is particularly an issue if the side road is not well defined by sidewalks and curves, so that a driver may feel that it is acceptable to drive outside the normal traffic flow of the side road. Also, when visibility drops at night or during rain storms, there is a stronger likelihood that a driver might not see a sign post when approaching it from the side. When a driver hits a sign post with a vehicle, it is likely that the driver will destroy the sign post, damage the sign(s) that it supports, and also damage the driver's vehicle. Upon hitting a sign post, a driver may also lose control of a vehicle and either strike other vehicles and/or damage other property. The cost to replace and/or repair a sign and sign post that have been hit by a vehicle is relatively high, and federal, state, and local governments would much prefer to prevent such damage by making sign posts more visible so that drivers can see them and avoid hitting them.

To improve the visibility of sign posts, reflective products have been developed that can be attached to the front surface of a sign post. However, such products do not provide any additional visibility when the sign post is viewed from the side. Accordingly, it would be desirable to improve the visibility of a sign posts from the side as well as from the front of a road sign supported by the sign post. It would also be desirable to enable this add-on product to be easily attached to an existing sign post.

### SUMMARY

A three-sided reflector is configured to encompass a sign post and includes a sheet of material formed into a U-shaped channel having a front, and two sides. The U-shaped channel is sized to fit around the sign post. A highly visible material is disposed on an outer surface of the front and each of the two sides of the U-shaped channel, so that light striking any of the front and the two sides of the U-shaped channel is more visible when reflected to an observer. The reflected light causes each of the front and each of the two sides to be more visible to a driver of an oncoming vehicle approaching the front or either of the two sides, compared to light reflected from the sign post, to reduce a likelihood that the sign post will be inadvertently struck by a vehicle.

As used herein, the term “highly visible material” is intended to encompass a material that has a bright or fluorescent color that is very visually perceivable in contrast to natural colors in the environment, and/or has a retro reflector characteristic achieved, for example, by using glass beads or micro-prisms. Examples of bright colors are the red color normally used for stops signs, the yellow color typically used for warning signs or school signs, and the blue typically used for the background color on informational road signs. Examples of fluorescent colors include the fluorescent pink used as a background color on incident management road signs, and the fluorescent yellow-green color used for a background color on pedestrian, bicycle, and school warning road signs. Bright and fluorescent colors are very easily perceived during daylight and even at dawn or dusk, since the colors stand out in contrast to the surrounding ambient colors. Retro reflector materials can be included as part of a bright or fluorescent color. In contrast to a conventional surface that diffuses light incident on the surface, a retro reflector tends to reflect light that is incident generally back along the angle of incidence. Thus, at night, a material that includes retro reflectors, such as glass beads or microprisms, will reflect the light from a vehicles headlight back toward the driver, making the surface that is covered with the material much more visible than a conventional painted surface. Accordingly, the term “highly visible” as used in connection with the material applied to the three-sided reflector refers is intended to be either bright colored, fluorescent colored, and/or retro reflective.

Another aspect that is described below is directed to a method for enhancing a visibility of a sign post. The method includes providing a three-sided reflector, as discussed above. The three-sided reflector is shaped as a U-channel and sized to encompass the sign post, covering at least part of a front of the sign post, and opposite sides of the sign post. Further, the three-sided reflector has a highly visible outer front surface and highly visible adjacent outer side surfaces. The three-sided reflector is then attached to the sign post so that the outer front surface of the three-sided reflector faces in a desired direction relative to the sign post. The highly visible outer front surface and the highly visible adjacent outer side surfaces of the three-sided reflector reflect light in a direction toward an oncoming vehicle, to increase a visual perception of the sign post by a driver of the oncoming vehicle. The reflected light reduces a likelihood that the driver of the oncoming vehicle will fail to perceive the sign post and strike the sign post with the vehicle.

Yet another aspect that is described below is directed to a method for creating a three-sided reflector for use on a sign post. The method includes forming a sheet of material into a U-channel having a front and two adjacent sides. The U-channel is sized to encompass a sign post. A highly visible material is then applied to at least a portion of an outer surface of the front and to at least a portion of outer surfaces of each the two adjacent sides of the U-channel.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1A (Prior Art) illustrates a front elevational view of an exemplary generally conventional road sign supported on a square or rectangular sign post;

FIG. 1B (Prior Art) illustrates a side elevational view of the road sign and sign post of FIG. 1A;

FIG. 2 illustrates a front elevational view of an exemplary embodiment of a three-sided reflector that has been attached to the sign post supporting the exemplary road sign shown in FIG. 1;

FIGS. 3A and 3B respectively illustrate isometric views from the rear and one side, and from the front and one side of the exemplary embodiment of the three-sided reflector shown in FIG. 2; and

FIG. 4 illustrates a top cross-sectional view of the exemplary three-sided reflector of FIGS. 2, 3A, 3B and a sign post to which it has been secured, showing how light is reflected from each of the outer surfaces of the three-sided reflector.

### DESCRIPTION

### Figures and Disclosed Embodiments Are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein. Further, it should be understood that any feature of one embodiment disclosed herein can be combined with one or more features of any other embodiment that is disclosed, unless otherwise indicated.

Sign posts can be formed from a variety of materials and in a variety of configurations. For example, and without any implied limitation, sign posts can be made from stainless steel, aluminum, galvanized steel, or plastic, and they can be formed to have a round, square, or rectangular cross section, or can have a more complex shape, such as a U-channel, or T-shaped post.

Break-away sign posts are available that include a short bottom section that is driven into the ground or set in concrete or other material, and an upper section that is attached to the bottom section with threaded fasteners. If struck by a vehicle, the upper section more readily breaks away from the bottom section to minimize damage to the vehicle, but the upper section and road sign will likely still need to be replaced in that event.

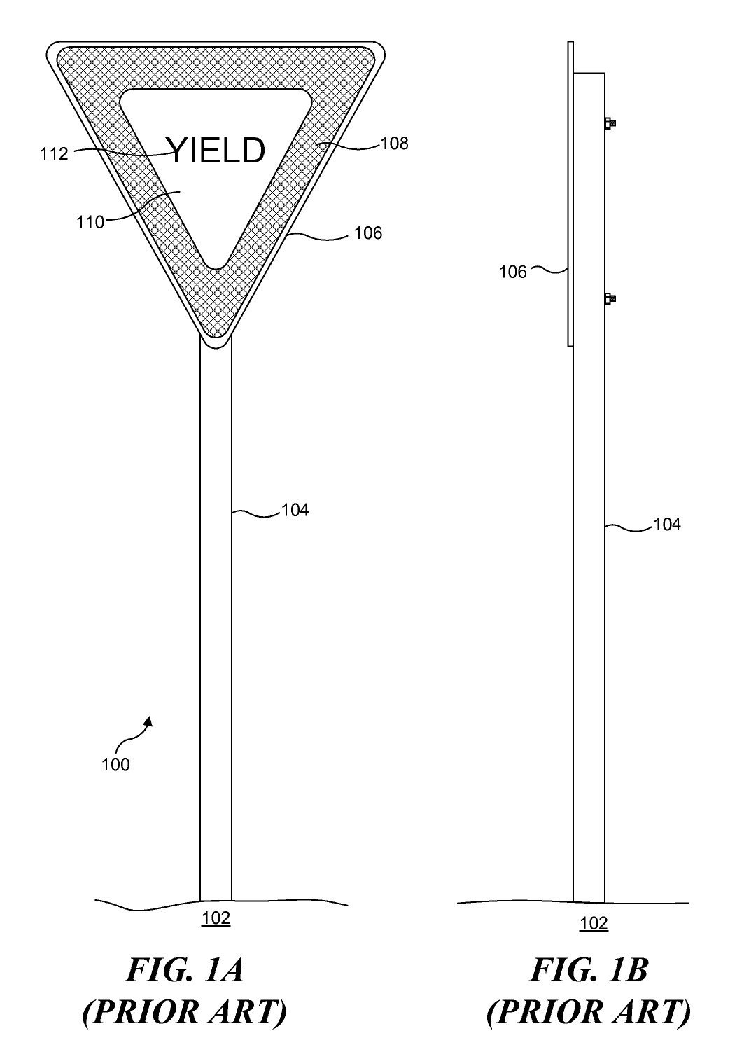

FIG. 1A (Prior Art) illustrates a front view of a combination 100 of a conventional square cross-section sign post 104 having a lower end that is buried in ground 102 (or set in concrete) and which is used for supporting a road sign 106. If a break-away sign post is used, the lower end of sign post 104 would be attached to a lower section of the sign post that is buried in the ground or set in concrete. In this example, road sign 106 is intended to alert oncoming drivers to yield to traffic on a cross road (not shown) and includes a highly reflective red triangular perimeter area 108 that surrounds a bright white reflective area 110. “YIELD” appears as a bright red reflective word 112 in white reflective area 110. Road sign 106 is readily visible from the front either during the daytime or at night. A vehicle's headlights or ambient light is reflected from the front face of road sign 106, so that the road sign is very visible to the drive of a vehicle approaching the sign from its front side, as is illustrated in this Figure. There is no reflective material or any other material on sign post 104 to increase its visibility, and it is much less visible, even to a driver approaching the front surface of road sign 106 than is the road sign.

FIG. 1B (Prior Art) illustrates combination sign post 104 and road sign 106 from the side. As shown in this view, it will be apparent that a driver approaching this side or the opposite side of road sign 106 will not have the benefit of the reflective front surface of the road sign to increase the visibility of the road sign and sign post combination. Also, road sign 106 and sign post 104 present a much smaller combined area when viewed from the side, and the sides of the road sign and sign post do not include any highly visible surfaces to reflect ambient light or vehicle headlights. It will therefore be apparent that a driver may fail to see the road sign and sign post from the side and will be more likely to hit sign post 104 as a result. It is also apparent that a driver approaching the rear of road sign 106 will not have the benefit of the highly visible front surface of the road sign to make the road sign more visible. Thus, when approached by a driver from the rear of the road sign, the road sign will be less likely to be perceived by the driver than when approached from the front of the road.

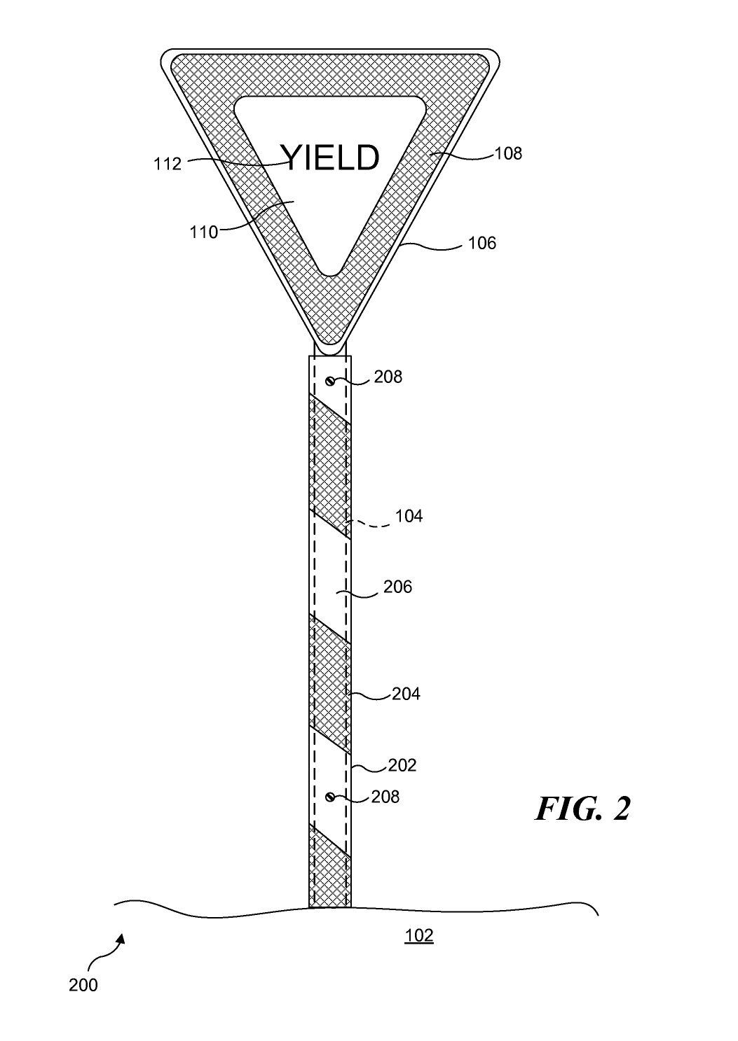

FIG. 2 illustrates a combination 200 of sign post 104 and road sign 106, as described in connection with FIGS. 1A and 1B, and an exemplary embodiment of a three-sided reflector 202. In this view, only one of the three reflective sides of reflector 202 is visible. For this exemplary embodiment, three-sided reflector 202 has alternating diagonal reflective stripes on each of the three-sides of the reflector, including bright red reflective stripes 204 that alternate with bright white (or silver) reflective strips 206. The bright red and bright white (or silver) stripes can also include retro reflectors, such as glass beads or micro-prisms. Three-sided reflector 202 generally fits around sign post 104, covering most of its front surface and both side surfaces. Thus, the bright reflective and highly visible surfaces of three-sided reflector 202 are disposed to reflect light toward a driver approaching road sign 106 from its front and from both sides. Since drivers do not normally approach the rear side of sign post 104 in a traffic lane where the driver might likely fail to see the sign post and strike it with a vehicle, there is normally little reason to provide a reflective surface on the back side of the sign post. However, it should be noted that in some applications, it may be desirable for the three-sided reflector to be mounted on a sign post so that the front of the reflector is directed toward one side of the sign post and side and not toward the front of the road sign and sign post. For example, if the sign post is mounted on the side of a roadway at a “T” intersection where the road sign faces oncoming traffic on the through roadway, then it would be beneficial to mount the three-sided reflector so that one of the sides of the reflector faces toward oncoming traffic in one direction, and the other side of the reflector faces toward traffic moving in the opposite direction. The front of the sign would face toward the traffic coming toward a side of the road sign (i.e., on the roadway corresponding to the lower portion of the “T.” There are other situations in which the three-sided reflector may be oriented with the front surface of the reflector facing in any desired direction relative to the sign post and road sign.

Three-sided reflector 202 is secured to sign post 104 using two threaded fasteners 208 in this example, although more or fewer fasteners and other types of fasteners, such a pop rivets, can be used for this purpose. It is also contemplated that three-sided reflector 202 can be adhesively attached to a sign post using an appropriate adhesive, such as epoxy.

Clearly, the specific road sign supported by the sign post with which the three-sided reflector is used is no consequence in regard to the benefit that the three-sided reflector provides. Some types of road signs may require support by a plurality of sign posts, any one or more of which may have the three-sided reflector attached. For example, if a road sign requires two sign posts, if desired, three sided reflector 202 can be attached to each sign post. Alternatively, if one of the sign posts is disposed in a location where it is very unlikely to be struck by a vehicle, it may be desirable to attach three-sided reflector 202 to only the sign post that is more likely to be struck by a vehicle if not seen by a driver.

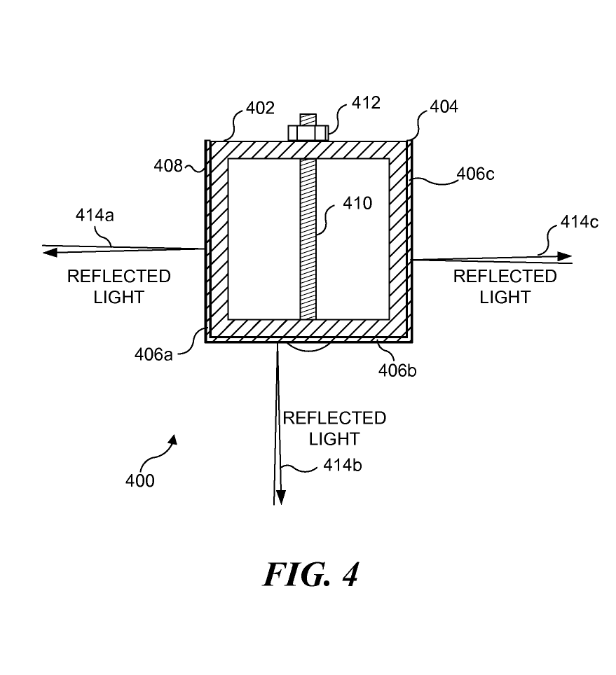

In addition, it must be emphasized that although sign post 104 is formed of square cross-sectional metal tubing in this example, three sided reflector can be used with other types of sign posts that have a different cross-sectional shape and which can be formed of other types of materials. For example, and without any implied limitation, three-sided reflector 202 can be attached to a rectangular or round cross-sectional sign post, as well as to U-channel or T-shaped sign posts using an appropriate fastener or adhesive. Further, the sign post to which the three-sided reflector is attached may be made of materials other than steel, such as aluminum, other metals, plastic, or wood, by way of example. A plastic three-sided reflector might be extruded in the U-channel shape of the three-sided reflector. Also, although the three-sided reflector may be made with each side having the same area or same transverse dimension (i.e., width), it is also contemplated that for some sign posts, it may be preferable to provide a three-sided reflector that has a front area that is either greater or less than the areas of the sides of the reflector and/or to provide different areas for the two opposite sides of the three-sided reflector. A key and important aspect of the three-sided reflector is that it provide a highly visible surface on the opposite sides—as well as on the front of the reflector. The benefit of the high visibility from three sides will be further evident from the discussion that follows in regard to FIG. 4.

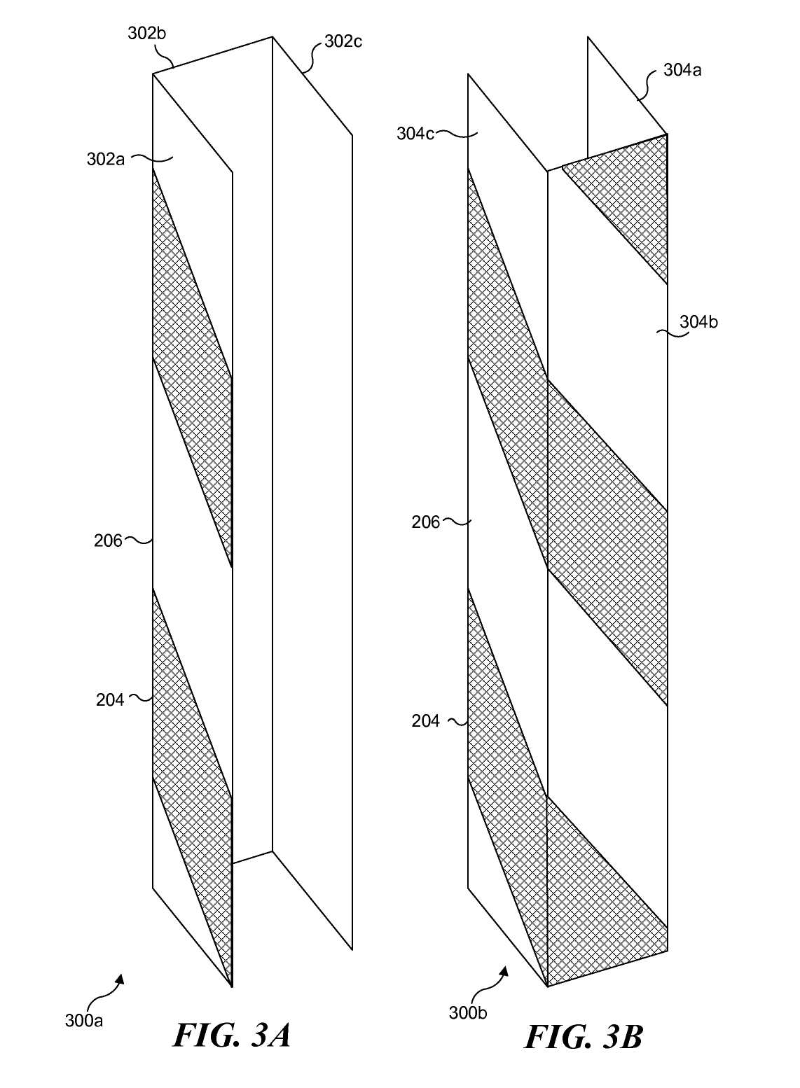

FIGS. 3A and 3B respectively illustrate exemplary three-sided reflectors 300a and 300b, showing rear and side views, and front and side views of the respective three-sided reflectors. As described above, each three-sided reflector includes alternating diagonal highly visible and reflective stripes, including highly visible red strips 204 and highly visible white stripes 206. These high visibility stripes extend around outer three surfaces 302a, 302b, and 302c of three-sided reflector 300a, and around outer three surfaces 304a, 304b, and 304c of three-sided reflector 300b. The three-sided reflectors are formed, for example, using a metal brake press to create two 90° angles in a strip of aluminum sheet metal that is the desired length of the three-sided reflector, so that a front side, e.g., surface 302b is formed with adjacent side surfaces, e.g., surfaces 302a and 302c. Other types of metal or other materials can be employed for producing the three-sided reflector.

Next, in this exemplary embodiment, a of highly visible plastic film is adherently applied to all three outer surfaces of the three-sided reflector. This type of highly visible reflective film (which can be supplied, for example, as a tape or sheet) is commercially available from suppliers such as 3-M Company, Avery Dennison Corporation, and Nippon Carbide Industries, Inc.—to name a few. While a reflective pattern of alternating bright red and bright white (or silver) diagonal strips is illustrated in the exemplary embodiments discussed above, it must be emphasized that other types of highly visible reflective patterns and colors may instead be applied to the outer three surfaces of a three-sided reflector, within the scope of the claims that follow below. One or more of the highly visible colors may also include retro reflectors. Thus, for example, the reflective material that is applied to the three outer surfaces may be a single highly visible color, or may include horizontal or vertical stripes or other patterns of two or more highly visible colors. Another option would be to apply the reflective material to only a portion of each of the surfaces of the three-sided reflector, since the highly visible reflective material would still provide improved visibility compared to using no reflective material. It is also contemplated that instead of an adherently attached highly visible reflective film, the highly visible material applied to the three surfaces of the three-sided reflector may be painted on or otherwise applied as a fluid to each outer surface of the three-sided reflector in any other suitable manner.

FIG. 4 illustrates a top cross-sectional view 400 of an exemplary three-sided reflector 404 that has been attached to a square cross-sectional sign post 402 and helps to make clear the advantages of the three-sided reflector. Three-sided reflector 404 includes outer surfaces 406a, 406b, and 406c. A highly visible film 408, for example, like that described above, has been applied to each of outer surfaces 406a, 406b, and 406c. If this type of reflective material includes retro reflectors, it can have a characteristic coefficient of retro-reflection ranging from about 5 to about 580 cd/lx/m² (measured at an observation angle of 0.2° and an entrance angle of −4.0°)—depending upon the type and color of the reflective film. The three-sided reflector has been attached and secured to sign post 402 using one or more threaded fastener(s) 410, which extend through orifice(s) (not shown) formed in outer surface 406b and in the front and back surface of sign post 402. An appropriate nut is threaded onto threaded fastener 410 to secure three-sided reflector 404 to sign post 402.

Light from a vehicle headlight or ambient light that is incident on highly visible film 408, where it covers each outer surface 406a, 406b, or 406, is reflected back toward the source by the retro reflectors included in the highly visible film. The light from a vehicle's headlamps that is incident on any of these outer surfaces will be reflected back by the retro reflectors in the film toward the vehicle and readily be visible by the driver of the vehicle. During the daytime, or during the time between day and night, the use of fluorescent and/or bright colors in the highly visible film will enable each outer surface of the three-sided reflector to be very visible to a driver, because of the contrast between the highly visible film and the surrounding ambient environment. Thus, in the examples shown, light 414a is reflected from outer surface 406a, or light 414b is reflected from outer surface 406b, or light 414c is reflected from outer surface 406c and is very visible to a driver of an approach vehicle—regardless of the lighting. The important point to note from these examples is that the visibility of sign post 402 has been greatly enhanced in regard to a driver approaching the sign post from any of the three sides of sign post 402 covered by the three-sided reflector. Accordingly, it is much less likely that a driver approaching sign post 402 from any of these three directions would fail to see the sign post and accidentally hit it. Therefore, the likelihood of a driver having such an accident is greatly decreased by attaching three-sided reflector 404 to the sign post.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

What is claimed is:

1. A three-sided reflector configured to encompass a sign post, comprising:
(a) a sheet of material formed into a U-shaped channel that includes a front, and two sides, wherein the U-shaped channel is sized to fit around the sign post; and
(b) a highly visible material disposed on the front and each of the two sides of the U-shaped channel, so that light striking any of the front and the two sides of the U-shaped channel is reflected in a highly visible manner, thereby causing each of the front and each of the two sides to be more visible to a driver of an oncoming vehicle approaching the front or either of the two sides, to reduce a likelihood that the sign post will be inadvertently struck by a vehicle.

2. The three-sided reflector of claim 1, wherein the sheet of material comprises a metal.

3. The three-sided reflector of claim 1, wherein the highly visible material comprises a highly visible reflective film that is adherently attached to each of the front and two opposite sides of the U-shaped channel.

4. The three-sided reflector of claim 1, wherein the highly visible material comprises a tape or a sheet of a highly visible material that is adherently attached to the front and to the two sides of the U-shaped channel.

5. The three-sided reflector of claim 1, wherein the highly visible material comprises a plastic film that includes retro reflectors.

6. The three-sided reflector of claim 1, wherein the highly visible material is applied as a fluid to the front and two sides of the U-channel.

7. The three-sided reflector of claim 1, wherein the highly visible material comprises alternating areas having a plurality of different colors that have a characteristic color that is either bright or fluorescent.

8. The three-sided reflector of claim 1, wherein the sheet of material comprises a plastic.

9. The three-sided reflector of claim 1, further comprising at least one fastener for attaching the three-sided reflector to the sign post.

10. The three-sided reflector of claim 1, wherein the highly visible material has a coefficient of retro-reflection ranging from about 5 to about 580 cd/lx/m², as a function of a color and a type of the highly visible material, when measured at an observation angle of 0.2° and an entrance angle of −4.0°.

11. A method for enhancing a visibility of a sign post, comprising:
(a) providing a three-sided reflector that is shaped as a U-channel and sized to encompass the sign post, covering at least part of a front of the sign post, and opposite sides of the sign post, the three-sided reflector having a highly visible outer front surface and highly visible adjacent outer side surfaces; and
(b) attaching the three-sided reflector to the sign post so that the outer front surface of the three-sided reflector faces in a desired direction relative to a front of the sign post, wherein the highly visible outer front surface and the highly visible adjacent outer side surfaces of the three-sided reflector reflect light in a direction toward an oncoming vehicle to increase a visual perception of the sign post by a driver of the oncoming vehicle, reducing a likelihood that the driver of the oncoming vehicle will fail to perceive the sign post and strike the sign post with the vehicle.

12. The method of claim 11, further comprising providing a plurality of different highly visible colors on the outer front surface and on the adjacent outer side surfaces of the three-sided reflector.

13. The method of claim 11, wherein attaching the three-sided reflector comprises attaching the three-sided reflector to the sign post with at least one fastener.

14. A method for creating a three-sided reflector for use on a sign post, comprising:
(a) forming a sheet of material into a U-channel having a front and two adjacent sides, wherein the U-channel is sized to encompass a sign post; and
(b) applying a highly visible material to at least a portion of an outer surface of the front and to at least a portion of outer surfaces of each the two adjacent sides of the U-channel.

15. The method of claim 14, further comprising providing at least one fastener for attaching the three-sided reflector to a sign post.

16. The method of claim 14, wherein forming the sheet of material comprises bending a metal strip to produce the U-channel using a brake press to form the metal strip to include an angle of about 90° where each side is joined to the front of U-channel.

17. The method of claim 14, wherein forming the sheet of material comprises extruding the U-channel from a plastic material.

18. The method of claim 14, wherein applying the highly visible material comprises adhering either a film or a tape of the highly visible material to each of the outer surfaces of the front and two adjacent sides of the U-channel.

19. The method of claim 14, wherein applying the highly visible material comprises applying a fluid comprising the highly visible material to each of the outer surfaces of the front and two adjacent sides of the U-channel.

20. The method of claim 14, wherein applying the highly visible material comprises applying a plurality of different colors of the highly visible material to each of the outer surfaces of the front and two adjacent sides of the U-channel.
